(19) United States
(12) Patent Application Publication
(10) Pub. No.: US 2013/0273248 A1
(43) Pub. Date: Oct. 17, 2013

(54) Methods and Devices for Making Glass Fiber Preforms

(71) Applicant: J-FIBER GMBH, Jena (DE)

(72) Inventors: Wolfgang Haemmerle, Jena (DE); Elke Poppitz, Jena (DE); Klaus Westhauser, Jena (DE); Lothar Brehm, Jena (DE)

(21) Appl. No.: 13/830,008

(22) Filed: Mar. 14, 2013

(30) Foreign Application Priority Data
Apr. 17, 2012 (DE) DE102012007684.3
Apr. 30, 2012 (DE) DE102012008848.5

(51) Int. Cl. C03C 25/22

(52) U.S. Cl. CPC C03C 25/223
USPC 427/237; 118/725

(57) ABSTRACT

Methods and devices for the production of glass fiber preforms are disclosed. The methods and devices are based on a modified chemical vapour deposition process wherein the reacting gases are reacted in a hot zone within a substrate tube. Glass layers are deposited by a first heating instrument moving with respect to the substrate tube. The reaction gases are subjected to a temperature treatment before entering the hot zone of the main burner to encourage an evenly distributed chemical reaction, deposition and doping concentration over the length of the substrate tube. This is based on the position of the substrate tube with respect to the heating instrument and the resulting different heating of the reaction gases.

### BACKGROUND

The modified chemical vapour deposition (MCVD) process is an inside deposition method characterized by a directed flow of the reacting gases inside a substrate tube. The formation of glass soot occurs in the hot zone of a heating source. The heating source is typically an oxygen/hydrogen burner. The created soot is deposited downstream of the burner on the inside of the substrate tube due to thermophoresis and is fused during the downstream movement of the burner to create transparent layers of glass. At the end of the tube, the heating source is shut down, or the power is significantly reduced, and the burner is positioned back at a starting point of the substrate tube. At this point the burner is turned on and the procedure is repeated to produce the next glass layer. Therefore, an equal stream direction of the reacting gases and the deposition of the glass soot within the hot zone on the inner tube wall are the characteristics of the MCVD process.

During this partial and local heating of the substrate tube, the substrate tube exhibits an unsymmetrical temperature distribution over its length, specifically upstream from the burner with respect to the direction of the gas flow. As the burner is passed forward along the substrate tube, the locally heated area of the substrate tube left behind is slowly cooled down due to the outer atmosphere and the reacting gases which are injected cold at the entrance of the tube. The stream of reacting gases is heated passively from room temperature at the tube entrance to a maximum temperature just before entering the hot burner zone, typically at the end of the tube.

To produce glass soot by MCVD, the reacting gases are converted within the hot zone as follows:

SiCl₄+O₂→SiO₂+2Cl₂ (1)

GeCl₄+O₂→GeO₂+2Cl₂ (2)

2POCl₃+1.5O₂→P₂O₅+3Cl₂ (3)

The mixture of reacting gases typically consists of SiCl₄, GeCl₄, POCl₃ and the carrier gases O₂ and He. Hydrogen/Oxygen burners are typically used as heating sources/burners.

A device and a method for the production of a preform for glass fibers using the MCVD process is taught in DE 199 29 312 A1. This device consists of a burner to heat a rotating tube during movement in a predetermined direction. The device consists of a first low pressure flame burner to heat the substrate tube, in which the first burner is located in front with respect to the movement direction. The device further includes a second high pressure flame burner for heating the substrate tube, where the second burner is located in the back with respect to the movement direction. The first and second burners are selectively used to deposit and/or collapse the tube to reduce the period and temperature of the collapsing process. So DE 199 29 312 A1 proposes a solution which uses the front end ring-shaped burner with low pressure flame to generate and deposit glass soot and the back end burner with high pressure flame to collapse the inner coated tube.

It is known that a problem with the deposition of doped glass layers during the MCVD process is the difference in the temperature of the reacting gases when entering the hot zone of the main burner during a deposition pass and/or during different deposition passes.

These temperature differences of the entering reaction gases during the chemical reaction in the hot reaction zone influence the chemical reaction to alter the refractive index of the single glass layers over the tube length. It remains desirable to have methods and devices that avoid unwanted changes of optical parameters, e.g. numerical aperture or refractive index profile, over the length of the preform.

### SUMMARY

The present invention is directed to methods and devices for the production of glass fiber preforms based on a modified chemical vapour deposition (MCVD) process, wherein the reacting gases of the process are reacted in a hot zone within a substrate tube and the resulting glass soot is deposited by the relative movement of a heating source creating the hot zone in the substrate tube. It is an objective of this invention to overcome the problems described above and provide methods and devices to optimise the uniformity of the deposition conditions over the length of a preform to yield high quality glass fiber preforms.

Methods and devices (or apparatus) for the production of glass fiber preforms use an MCVD process that converts the reaction gases in a hot zone within a substrate tube (step 14 of FIG. 3) and deposits the glass layers. Further, movement of a heating source creates a hot zone inside the substrate tube (step 16 of FIG. 3). The substrate tube is also rotated. The apparatus and methods subject the reaction gases prior to entering the hot zone to a controlled temperature conditioning process (step 12 of FIG. 3) which aims for a uniform chemical reaction, deposition and therefore also a uniform doping concentration over the length of the substrate tube. The temperature conditioning is correlated to the position of the substrate tube and respective different preheating or cooling of the reaction gases.

In a preferred embodiment, the amount of germanium doping in a silica layer is controlled, where above a certain process temperature interval, a reduction of the temperature results in an improved germanium doping, and an increase in temperature results in a reduction of germanium doping.

In a first alternative embodiment, a method for the production of glass fiber preforms is based on a MCVD process, wherein the reacting gases are converted in a hot zone within a substrate tube and glass layers are deposited by a first heating instrument moving with respect to the substrate tube. The reaction gases are subjected to a temperature treatment below the glass formation temperature before entering the substrate tube to yield an evenly distributed chemical reaction, deposition and doping concentration over the length of the substrate tube. This result is a product of the position of the substrate tube with respect to the heating instrument and the resulting different preheating of the reaction gases.

In a second alternative embodiment, a doping concentration of germanium in SiO₂-soot is controlled by this temperature treatment and a process temperature interval with a decrease in temperature results in an enhanced germanium doping and an increase in temperature results in a reduced germanium doping.

In a third alternative embodiment, the method includes adjusting the temperature of the reaction gases before entering the hot reaction zone to less than 1100° C.

In a fourth alternative embodiment, the method includes a temperature treatment that is carried out by a second heating instrument which is located within the reaction gas flow direction before the first heating instrument generating the hot zone. In an alternative arrangement, the second heating instrument is built in the form of a burner or a cooler, wherein a cooling gas is applied to the burner for cooling purposes.

In a fifth alternative embodiment, the method includes making a test preform (step 10 of FIG. 3) with a substrate tube length dependent deviation of the refractive index profile and wherein germanium doping is measured and used for applying a controlled temperature for the next preform to optimise the refractive index profile and germanium doping concentration.

In a further alternative embodiment, a device for the production of glass fiber preforms based on a MCVD process, wherein the reacting gases are converted in a hot zone within a substrate tube and glass layers are deposited by a first heating instrument moving with respect to the substrate tube characterized in that at the entrance of the reaction gases to the substrate tube a stationary and/or in close proximity to a first heating instrument and a second heating instrument is positioned, wherein the second heating instrument does not disturb the hot zone of the first heating instrument.

In an alternative arrangement, the device includes a moveable second heating instrument that is connected to the first heating instrument with respect to the relative movement to the substrate tube. In a further alternative arrangement, the second moveable heating instrument is covered with reflectors or flow forming panels or the like so that the hot zone of the first heating instrument is unaffected. In a still further alternative arrangement, the distance between the first heating instrument and the moveable second heating instrument is in the range of 5 to 30 cm, preferably in the range of 10 to 20 cm. In another alternative arrangement, the moveable heating instrument is connect rigidly with the heating instrument and undergoes a relative movement with respect to the substrate tube.

In an alternative embodiment, the device includes a cooling gas applied to the substrate tube. In an alternative arrangement, reaction gases are cooled with a second heating instrument in a non-flame mode.

In another alternative embodiment, the first heating instrument adjusts the temperature in the hot zone to 1300 to 2100° C. and the second heating instrument adjusts the temperature of the reaction gases to less than 1100° C. This means a preheating of the reaction gases as well as a cooling of the reaction gases.

In a further alternative embodiment, a second heating source is used to control temperature. The second heating source is located before the main burner in the flowing direction. In a first arrangement, this second heating source is configured as a burner. In a second arrangement, this second heating source is configured as cooler. The cooling by the second heating source is achieved by purging a coolant fluid, i.e. no combustion of this fluid takes place.

According to embodiments of the present invention, a test preform is produced to determine the difference of the refractive index profile and the correlated germanium doping concentration at different tube positions. Based on this doping profile, the reacting gases are heated to a controlled temperature leading to the desired amount of germanium doping necessary for an optimised refractive index of the deposited layers.

Further embodiments for the production of glass fiber preforms based on an MCVD process are characterized by a heating source positioned stationary at the entrance of the reacting gases into the substrate tube and/or a movable heating source in proximity to the burner generating the hot reaction zone. This heating instrument can be realized in the form of a common burner that does not interfere with the flame of the main burner.

In some embodiments having the second heating source, the second heating source is connected to the main heating source with respect to the relative movement to the substrate tube.

In further alternative embodiments, the second movable heating source is preferably equipped with reflecting parts, flow forming parts, or the like, to prevent influence on the main burner. Where applicable, an electronic controller of the temperature of the second heating instrument is used.

In a further alternative embodiment, the distance between the first heating instrument, i.e., the main burner generating the hot reaction zone, and the movable second heating instrument is between 5 and 30 cm, even more preferable between 10 and 20 cm.

In another alternative embodiment, the second moveable heating instrument is connected to the first heating instrument rigidly and may be positioned on the same support.

In another alternative embodiment, through the second heating instrument, a cooling gas may be applied to the substrate tube and or reacting gases when operating in a non-flame mode.

In another alternative embodiment, the first heating instrument is used for generating the hot zone temperatures in the range of 1300 to 2100°, and the second heating instrument is used to adjust the temperature of the reacting gases in a range of less than approximately 1100° C.

The present invention together with the above and other advantages may best be understood from the following detailed description of the embodiments of the invention illustrated in the drawings, wherein:

### DRAWINGS

FIG. 1 is a device for making glass fiber preforms according to principles of the invention;

FIG. 2 shows an alternative embodiment of the device of FIG. 1; and

FIG. 3 is a flowchart of the method of forming a glass fiber preform according to principles of the invention.

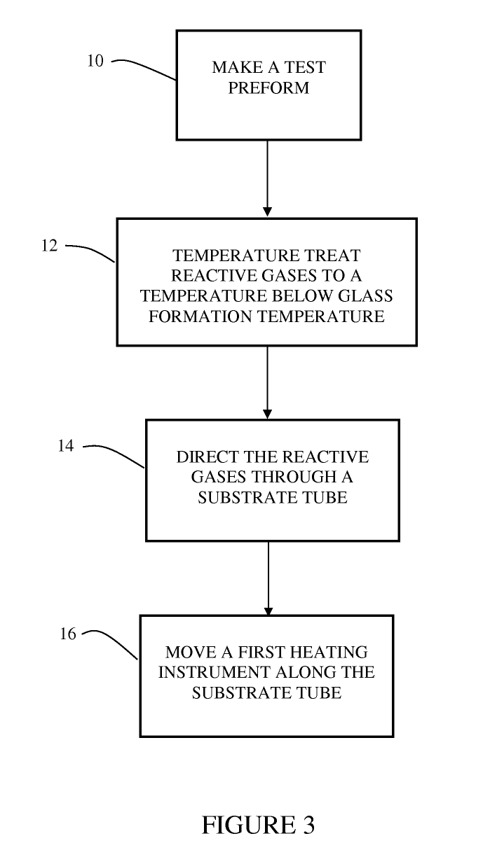

### DESCRIPTION

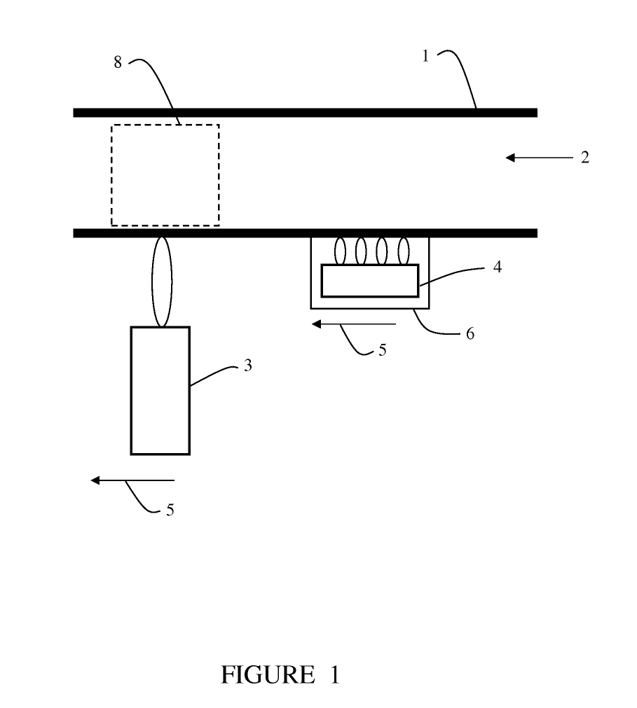

FIG. 1 shows a schematic view of a rotating substrate tube having an entrance for reactive gases, a configuration of a main, or first, heating instrument (also referred to as a burner) as well as a configuration of a second heating instrument (in some embodiments, a second burner which is a controllable additional burner) aiming at influencing the amount of germanium doping during the deposition process to minimize the length dependence of the radial refractive index profile.

According to FIG. 1, a substrate tube 1 is used, which is rotated during the deposition process.

This substrate tube 1 has a reaction gas entrance side 2. This side is defined as flow upstream side.

Preferably, below the substrate tube 1, a first heating instrument formed by a main burner 3 is used. The arrows 5 below the main burner indicate the direction of the deposition pass.

Connected to the main burner 3, i.e., first heating instrument, is a second heating instrument 4, which in the present embodiment is an additional burner. This second heating instrument 4 is surrounded by a housing 6 in a preferred embodiment so as not to disturb the hot zone flame form of the main burner. In some embodiments, the second heating instrument provides cooling rather than heating.

Embodiments of the present invention yield an optimised deposition condition over the length of the substrate tube due to the additional heating instrument or cooling device formed by the additional burner 4 upstream from the main burner 3 thereby balancing the different temperatures of the reactive gases at different substrate tube positions.

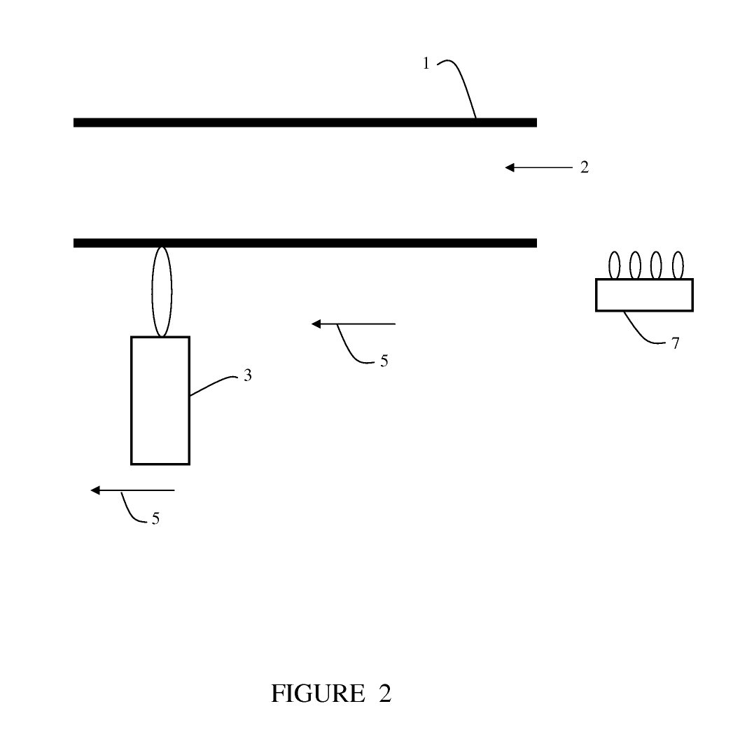

In one embodiment, the desirable temperature balance is achieved by mounting a rigid additional burner 7 before the substrate tube (shown in FIG. 2) to heat the reacting gases to a predetermined temperature which is correlated to the position of the main burner 3 with respect to the substrate tube.

In an alternative embodiment, the additional burner 4 is mounted so that it is moveable and also rigidly connected to the main burner 3.

The thermal energy applied to the substrate tube by the additional burners 4, 7 results in a temperature variation of the reacting gases prior to entering the hot zone 8 (above the main burner 3) which is adjusted so as to result in a constant doping concentration of germanium over the length of the substrate tube.

By this controlled influence of the reaction gas temperature over the length of the substrate tube, a constant doping concentration in the glass layer can be realized without any dependence of the position of the main burner.

This finally yields a preform with substantially constant parameters, e.g. core diameter or core refraction index profile, over the deposition length of the substrate tube.

The additional burner 4 located upstream from the main burner heats its section of the substrate tube to a lesser degree than the main burner. The heating temperature is controlled to be below the glass soot generating temperature of the reactive gases of approximately 1100° C. because the generation of glass soot is preferred to take place in the zone of the main burner 3.

The temperature range of less than 1100° C. ensures the mechanical stability of the substrate tube 1 by maintaining the viscosity of the glass high enough for the hot zone at the main burner 3.

The deposition of glass soot takes place downstream from the hot zone of the main burner 3. If the heating or cooling of the reactive gases by the additional burner 4 is not sufficient within the allowed temperature range of up to 1100° C., the length of the heating or cooling stage is increased to enlarge the time of the reaction gases within the heating or cooling zone of the additional burner.

Using a rigid additional burner for applying heat to solve the problem of refractive index differences related to the tube position bears the disadvantage that the applied thermal energy has to be calculated with respect to time-dependent flow velocity of the reactive gases from the additional burner to the main burner. This time depends on the overall flow volume and the velocity of the main burner, i.e., from the time-dependent distance between the additional burner and the main burner.

Another disadvantage of using a stationary additional burner at the entrance of the substrate tube is the problem in using the additional burner for cooling the reaction gases.

Therefore the above-mentioned problem can be overcome by the additional burner 4 of FIG. 1, where the stationary location of the additional versus the movable main burner is avoided.

The additional burner 4 is preferably positioned upstream of the main burner and has a constant distance from the main burner during one deposition pass. This means, that the position of the additional burner with respect to the substrate tube is changed. That is, the additional burner is moveable with respect to the substrate tube. In one embodiment, the additional burner is rigidly connected to the support of the main burner. The distance between the additional burner and the main burner is chosen so that the flame of the main burner is not influenced by the heating or cooling mode of the additional burner. A distance of 10 to 20 cm is preferred.

The different substrate tube temperature upstream of the main burner controls the temperature of the reacting gases prior to their entrance in the region of the hot zone of the main burner to correct the deviations of the doping concentrations. This corrects the refractive index profile of the preform as determined according to a target index profile.

The additional burner is preferably used at the beginning of the tube for heating and at the end of the tube for cooling the reaction gases according to the determined index profile corrections.

Furthermore the additional burner is covered by reflectors 6 and flow forming profiles to decouple the temperature setpoint from environmental conditions and to not influence the temperature control of the main burner. If high accuracy is necessary, a temperature control of the additional burner is within the scope of this invention.

The main burner can be built as a half shell burner wherein the rotational axis of the substrate tube lies above the center of the main burner. In an alternative embodiment, the additional burner is not built in half shell manner, but in a line shaped one. In this embodiment, the main axis of the additional burner is directed parallel to the centre line of the substrate tube. To enhance the effectiveness of the rectangular burner when heating the reaction gases, reflectors made of quartz glass can be positioned on the top and/or sides of the additional burner. To reduce the reaction time of the additional burner system, it is preferred to enhance the length of the rectangular burner according to customer needs. This enhances the residence time of the reaction gases within the substrate tube.

It is to be understood that the above-identified embodiments are simply illustrative of the principles of the invention. Various and other modifications and changes may be made by those skilled in the art which will embody the principles of the invention and fall within the spirit and scope thereof.

We claim:

1. A method for making a glass fiber preform, comprising:
temperature treating reactive gases to a temperature below glass formation temperature;
directing the treated reactive gases through a substrate tube; and
moving a first heating instrument along the substrate tube to react the reactive gases in the substrate tube such that a glass layer is deposited in the substrate tube.

2. The method of claim 1 wherein the reactive gases include SiO₂ and germanium and wherein a doping concentration of germanium in the glass layer is responsive to the temperature in the temperature treatment.

3. The method of claim 1 wherein the temperature of the reactive gases in the temperature treating step is less than 1100° C.

4. The method of claim 1 further comprising moving a second heating instrument along the substrate tube behind the first heating instrument.

5. The method of claim 1 wherein the second heating instrument is a cooler that utilizes a cooling gas.

6. The method of claim 4 further comprising the step of making a test preform to determine a substrate tube dependent deviation of a refractive index profile and to measure germanium doping to discover an effective temperature for the temperature treating step whereby the refractive index profile and germanium doping in the glass layer are optimized.

7. A device for making a glass fiber preform, comprising:
a first heating instrument configured to move along a substrate tube, the first heating instrument to create a hot zone in the substrate tube to react gases inside the substrate tube, and
a second heating instrument configured such that the second heating instrument does not effect the hot zone.

8. The device of claim 7 wherein the second heating instrument is positioned relative to the first heating instrument.

9. The device of claim 7 wherein the second heating instrument is positioned at an entrance of the substrate tube.

10. The device of claim 7 wherein the second heating instrument is moveable and further is moveable relative to the first heating instrument.

11. The device of claim 7 wherein the second heating instrument is moveable and further comprises reflectors configured and arranged to isolate the effect of the second heating instrument from the hot zone of the first heating instrument.

12. The device of claim 7 wherein the second heating instrument is moveable and further comprises flow forming panels configured and arranged to isolate the effect of the second heating instrument from the hot zone of the first heating instrument.

13. The device of claim 7 wherein the second heating instrument is positioned between 5 and 30 cm from the first heating instrument.

14. The device of claim 7 wherein the second heating instrument is moveable and further is connected rigidly with the first heating instrument.

15. The device of claim 7 wherein the second heating instrument uses a cooling gas to effect temperature in the substrate tube.

16. The device of claim 7 wherein the first heating instrument adjusts the temperature in the hot zone to 1300 to 2100° C. and wherein the second heating instrument adjusts the temperature of the reaction gases to less than 1100° C.
